(19) United States
(12) Patent Application Publication
(10) Pub. No.: US 2012/0269529 A1
(43) Pub. Date: Oct. 25, 2012

(54) Zero Leading and Trailing Margin Printing Method and an Electrophotographic Imaging Apparatus for Performing Same

(76) Inventors: Matthew David Heid, Simpsonville, KY (US); David John Mickan, Lexington, KY (US); Kevin Dean Schoedinger, Lexington, KY (US)

(21) Appl. No.: 13/093,513

(22) Filed: Apr. 25, 2011

(51) Int. Cl. G03G 15/16

(52) U.S. Cl. 399/66

(57) ABSTRACT

An electrophotographic imaging apparatus includes a feeding tray to feed a media sheet along a feed path in a process direction; a media sensor disposed on the feed path and triggered or changes state when a leading edge and a trailing edge of the media sheet arrives at the media sensor; an image carrying member adjacent to the media sensor and carrying a toner image thereon, and an transfer roll abuttingly coupled with the image carrying member to facilitate the transfer of the toner image from the image carrying member onto the media sheet. The electrophotographic imaging apparatus includes a controller for adjusting the setting of transfer roll voltage values based on the location of an image area on the media sheet. Further disclosed is a method for reproducing an original image on the media sheet using variable timing of transfer voltages.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Disclosure

The present disclosure relates generally to electrophotography, and more particularly, to an electrophotographic imaging apparatus and a method for top edge to bottom edge printing of images on a media sheet using the electrophotographic imaging apparatus.

2. Description of the Related Art

In electrophotography, an imaging operation (such as printing) is performed by an image forming apparatus/electrophotographic imaging apparatus that includes an electrically charged photoconductor drum carrying a toner image and an electrically charged transfer roller that facilitates transfer of the toner image from the photoconductor drum (“PC drum”) onto a media sheet. Specifically, the surface of the PC drum is discharged by a scanning laser beam forming an electrostatic latent image. The electrostatic latent image is converted to a toner image when charged toner particles are attracted onto the surface of the PC drum supplied from a charged developer roll. Subsequently, the toner image is transferred from the surface of the PC drum onto the media sheet as the media sheet is fed through the transfer nip between the PC drum and the transfer roller. During such an electrophotographic printing, the transfer roller is provided with a transfer voltage, i.e., thru-paper voltage (such as 4000 Volts (v)) in order to transfer the toner image from the PC drum onto the media sheet. The term “thru paper voltage” or TPV recognizes that the transfer voltage on the transfer roll is applied through the media sheet onto which the toner image is transferred.

Edge to edge printing, including top to bottom printing, is a growing user requirement for All-in-One (AIO) devices that scan full coverage documents with users expecting original-like images to be reproduced on media sheets. However, it is difficult to achieve full edge-to-edge print quality, particularly at the leading and trailing edges of the media sheet, with the currently available electrophotographic imaging apparatuses. During prior attempts at top (leading) edge to bottom (trailing) edge printing using an electrophotographic imaging apparatus, difficulties have been encountered because of various issues, such as contamination of the transfer roller by stray toner particles from the PC drum and imaging inaccuracies, leading to printed images of reduced quality. Further, currently available electrophotographic imaging apparatuses are tuned to provide high quality print quality up to default margins of about 4 millimeter (mm) from all edges of a media sheet. However, printing with zero width right and left side margins but with default top and bottom margins can be done. However, portions of images that are closer to an edge of the media sheet may have reduced print quality. Zero margin printing is more problematic when trying to print with zero width leading and trailing margins due to issues related to the potential fields that are present and contamination of the surface of the transfer roll found in electrophotographic printers. Surface contamination may lead to print artifacts on the opposite surface of the media which leads to print quality issues when duplex printing is to be performed, and if severe enough may interfere with the transfer of the toner image to the surface of the media.

Edge to edge printing, including leading edge to trailing edge printing, is a growing user requirement for All-in-One (AIO) devices that scan full coverage documents with users expecting original-like images to be reproduced on the printed media sheets without the white space caused by the presence of top, bottom and side margins. However, it is difficult to achieve full edge-to-edge print quality, particularly at the leading and trailing edges of the media sheet, with the currently available electrophotographic imaging apparatuses. Specifically to achieve high quality leading edge to bottom edge printing, the transfer voltage of a transfer roller of a conventional electrophotographic imaging apparatus must be at an optimum, i.e., the TPV is as high as 4000 v), to ensure sufficiently good transfer of a toner image entirely from a leading edge up to a trailing edge of a media sheet.

However, a PC drum should not be consistently directly exposed to the high potential field created by the high TPV in order to ensure long life of the PC drum and/or other components, such as a charging system for the PC drum. Further, exposure to the high TPV may bias the charge transport or charge generation layers found on the PC drum. The charging system may be unable to properly condition the surface of the PC drum for imaging a next media sheet, when the transfer voltage is maintained at the TPV when an earlier provided media sheet exits from the transfer nip between the PC drum and the transfer roller and no media sheet is present therein. To avoid this, the transfer voltage is adjusted a lower magnitude inter-page voltage, IPV, (typically 150 v), when a media sheet is not expected to be present in the transfer nip. A low IPV not only helps prevent damage to the PC drum but also averts the dissociation of toner particles from the PC drum, thereby preventing contamination of the transfer roller. The timings for the shift in transfer voltage of the transfer roller between TPV and IPV are explained in conjunction with FIG. 1.

FIGS. 1A-1C illustrate prior art fixed timing for the shift in transfer voltage between the TPV (typically between 650 v to 4000 v) and the IPV (150 v) of a transfer roller for an media sheet N and a subsequent media sheet N+1 moving in a process direction A as indicated by the large arrow. Each of the media sheets N and N+1 have leading 12 and trailing edges 14. Further, media sheets N and the N+1 are separated by an inter-page gap G. The term “leading” and “trailing” refer to the direction in which the media is being moved through the apparatus.

In FIGS. 1A-C, each media sheet N, N+1 etc. has a leading edge 12 and a trailing edge 14. In FIGS. 1A-B, the leading edge 10 of media sheet N, approaches the transfer nip 16, indicated by the cross-hatched rectangle. At P1 the transfer voltage increases from IPV to TPV as the leading edge 12 of media sheet N enters the transfer nip 16 and remains at this level until the trailing edge 14 of media sheet N approaches exiting the transfer nip 16 where at P2 the transfer voltage is lowered to IPV until the trailing edge 14 of media sheet N exits the transfer nip 16. In FIG. 1C, media sheet N has exited the transfer nip 16 while the transfer voltage was at IPV and while media sheet N+1 approaches transfer nip 16. At P3 the transfer voltage begins to rise from IPV to TPV as leading edge 12 of media sheet N+1 approaches the transfer nip 16 and reaches TPV after the leading edge 12 of media sheet N+1 has reached transfer nip 16. Consequently, any image content located near leading edge 12 suffers from poor toner transfer, thereby leading to print quality defects. The fixed timing process repeats for subsequent media sheets. A fixed timing approach ensures that the transfer voltage has reached the IPV level before each media sheet N, N+1 etc and particularly their trailing edges 14 exit the transfer nip 16. Consequently, any image content located near the trailing edge 14 of any exiting media sheet suffers from poor toner transfer leading to print quality defects.

Because of the interpage gap G between media sheets, the PC drum may undergo biasing and damage when the transfer voltage begins to rise from the IPV to the TPV just after the passage of each trailing edge 14 through the transfer nip 16. Further, as depicted at P3 in FIG. 1C, the transfer voltage starts rising from the IPV to the TPV when a leading edge 12 of the N+1 media sheet approaches the transfer nip 16. Such a fixed timing approach ensures that the transfer voltage has reached the TPV value after the arrival of the leading edge 12 of the N+1 media sheet at the transfer nip 16.

Accordingly, there persists a need for an efficient and effective electrophotographic imaging apparatus and method that provides sufficiently high print quality throughout the length of a media sheet without deleteriously affecting the PC drum of the electrophotographic imaging apparatus during shifts in the transfer voltage levels of a transfer roller of the electrophotographic imaging apparatus.

### SUMMARY

In view of the foregoing disadvantages inherent in the prior art, the general purpose of the present disclosure is to provide an electrophotographic imaging apparatus and a method for reproducing an original image on a media sheet, by including all the advantages of the prior art, and overcoming the drawbacks inherent therein.

In one aspect, the present disclosure provides an electrophotographic imaging apparatus that includes a feeding tray for feeding a media sheet along a feed path of the electrophotographic imaging apparatus in a process direction. The electrophotographic imaging apparatus further includes a media sensor disposed on the feed path which is triggered when a leading edge and a trailing of the media sheet arrives at the media sensor. The electrophotographic imaging apparatus includes an image carrying member positioned adjacent to the media sensor which carries a toner image thereon. The toner image corresponds to an original image that needs to be reproduced on the media sheet. Additionally, the electrophotographic imaging apparatus includes a transfer roll abuttingly coupled with the image carrying member to form a transfer nip therebetween. The transfer roll is adapted to facilitate the transfer of the toner image from the image carrying member onto the media sheet when the media sheet passes through the transfer nip.

Moreover, the electrophotographic imaging apparatus includes a controller operatively coupled with the media sensor and transfer roll and determining the dimensions of an image area containing the toner image to be reproduced and a first portion of the media sheet. The controller adjusting a transfer roll voltage between a first transfer voltage and a second transfer voltage based on the location of a leading edge and a location of a trailing edge of the image on the media sheet, the controller setting the transfer roll at a first transfer voltage when the leading edge of the image area arrives at the transfer nip. The controller further sets the transfer roll at a second transfer voltage when the controller determines one of completion of the arrival of the trailing edge of the image area onto the media sheet and arrival of the trailing edge at the transfer nip.

In another aspect, the present disclosure provides a method for reproducing an original image on a media sheet by the electrophotographic imaging apparatus. The method comprising determining an image area and a leading and trailing margin of the media sheet; driving the media sheet along a feed path of the electrophotographic imaging apparatus; determining the arrival of a leading edge and a trailing of the media sheet at a media sensor of the electrophotographic imaging apparatus; setting an transfer roll of the electrophotographic imaging apparatus at a first transfer voltage based on a first predetermined criterion; transferring a toner image from an image carrying member of the electrophotographic imaging apparatus on the media sheet; and setting the transfer roll at a second transfer voltage based on a second predetermined criterion. Further, the method includes terminating the determination of the arrival of the trailing edge of the media sheet at the media sensor when the image has been transferred prior to arrival of the trailing edge of the media sheet.

### BRIEF DESCRIPTION OF THE DRAWINGS

The above-mentioned and other features and advantages of the present disclosure, and the manner of attaining them, will become more apparent and will be better understood by reference to the following description of embodiments of the disclosure taken in conjunction with the accompanying drawings.

FIG. 1A-C illustrates prior art timings for shift in transfer voltage between TPV voltage and IPV of a transfer roller of a conventional electrophotographic imaging apparatus.

FIG. 2 illustrates a media sheet and having leading, trailing and left and right margins defining a border and a print area.

FIG. 3 illustrates an electrophotographic imaging apparatus incorporating the present method.

FIG. 4 illustrates timing diagrams for two media sheet depicting both fixed and variable timing for setting of the transfer voltage for two media sheets where one of the media sheets has a leading and trailing margin and the other of the media sheets requires leading edge to bottom edge printing.

FIG. 5A illustrates the printable area in black of a printed media sheet obtained using the fixed timing of FIG. 4 and FIG. 5B illustrates the printable area in black of a printed media sheet obtained using the adjustable timing of FIG. 3.

FIG. 6 illustrates a time versus voltage graph for a conventional media sheet based timing and the adjustable timing of the transfer roll for the shift in the transfer voltage between the TPV voltage and the IPV.

FIG. 7 illustrates a graph depicting a comparison of transfer voltage slew rates for conventional electrophotographic imaging apparatuses with transfer slew rates for the electrophotographic imaging apparatus of FIG. 2.

FIG. 8 illustrates a flow chart depicting a method for reproducing an original image on a media sheet by utilizing the electrophotographic imaging apparatus of FIG. 2.

FIGS. 9A and 9B illustrate a flow chart depicting a method of reproducing the original image on the media sheet by utilizing the electrophotographic imaging apparatus of FIG. 2, in accordance with another aspect of the present disclosure.

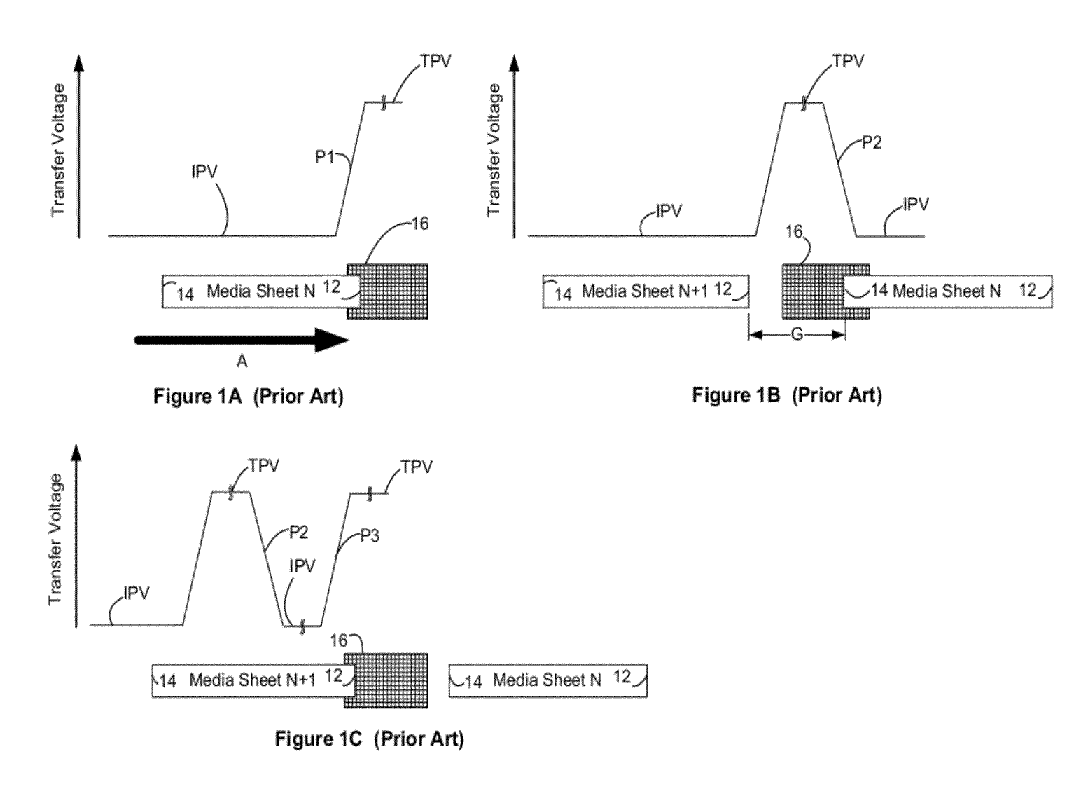

### DETAILED DESCRIPTION

It is to be understood that various omissions and substitutions of equivalents are contemplated as circumstances may suggest or render expedient, but these are intended to cover the application or implementation without departing from the spirit or scope of the claims of the present disclosure. It is to be understood that the present disclosure is not limited in its application to the details of components set forth in the following description. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item. The term “process direction” is the direction in which media sheets are transferred through the imaging apparatus from input to output. The terms “leading edge” and “trailing edge” are used in reference to the process direction where the leading edge is downstream of the trailing edge when the media sheets moves in the process direction. The leading and trailing edges may also be the top and bottom edges, respectively of the image when the media sheet is in a portrait orientation while the leading and trailing edges may be the left and right side edges, respectively, when the media sheet is in a landscape orientation.

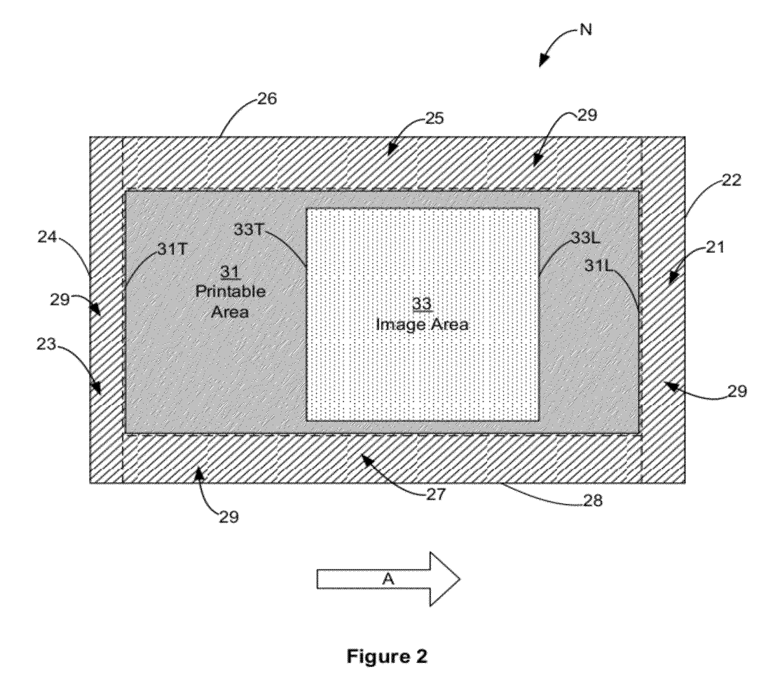

As shown in FIG. 2, is a media sheet N positioned in a portrait orientation in the process direction indicated by the arrow A. In relation to the process direction A, the various portions of media sheet N are: a leading edge 22, a trailing edge 24, a left edge 26, a right edge 28, a leading margin 21, a trailing margin 23 and a left margin 25 and a right margin 27. The leading margin 21 extends between the left and right edges 26, 28 and from the leading edge 22 a predetermined height toward the trailing edge 24 and conversely for the trailing margin 23. The left margin 25 extends a predetermined width from the left edge 26 toward the right edge 28 and conversely for the right margin 27. The left and right margins 25, 27 extend between the leading and trailing margins 21, 23. The leading and trailing margins 21, 23 may have the same or different heights. The left and right margins 25, 27 may have the same or different widths. The four marginal portions 21, 23, 25, 27 define a border 29 indicated by the cross hatching. The leading and trailing margins 21, 23 may have the same or different heights. The left and right margins 25, 27 may have the same or different widths. Typically while no printing will occur within the border 29, it may occur.

On media sheet N, a printable area 31 (shown as a gray box) is shown and is the region surrounded by the border 29 (shown in cross hatching) into which the image area 33 (shown as the stippled box) containing the image data to be reproduced will be positioned. For purposes of illustration only, the printable area 31 is shown as being slightly smaller than the border 29 in order show the dashed lines indicating the edges of the four margins abutting the printable area 31. The image area 33 is the overall area on the media sheet N that will contain image data that may fill the image area 33 or cover only a portion or portions thereof. The image area 33 may fill the printable area 31 or only a portion or portions thereof as illustrated. The printable area 31 has leading and trailing edges 31L and 31T while the image area has leading and trailing edges 33L and 33T for the process direction indicated by arrow A. For edge to edge printing or borderless printing, the leading and trailing margins 21, 23 would have zero height while the left and right margins 25, 27 would have zero width. Alternatively, edge to edge printing may be described as a zero width border 29; be described as the printable area 31 being coextensive with the surface area of the media sheet N while the image area 33 is coextensive with the printable area 31 or that the printable area 31, the image area 33 and the surface area of the media sheet N are mutually coextensive. For leading edge to trailing edge printing the leading and trailing margins would have a zero height while the right and left margins may have a nonzero width.

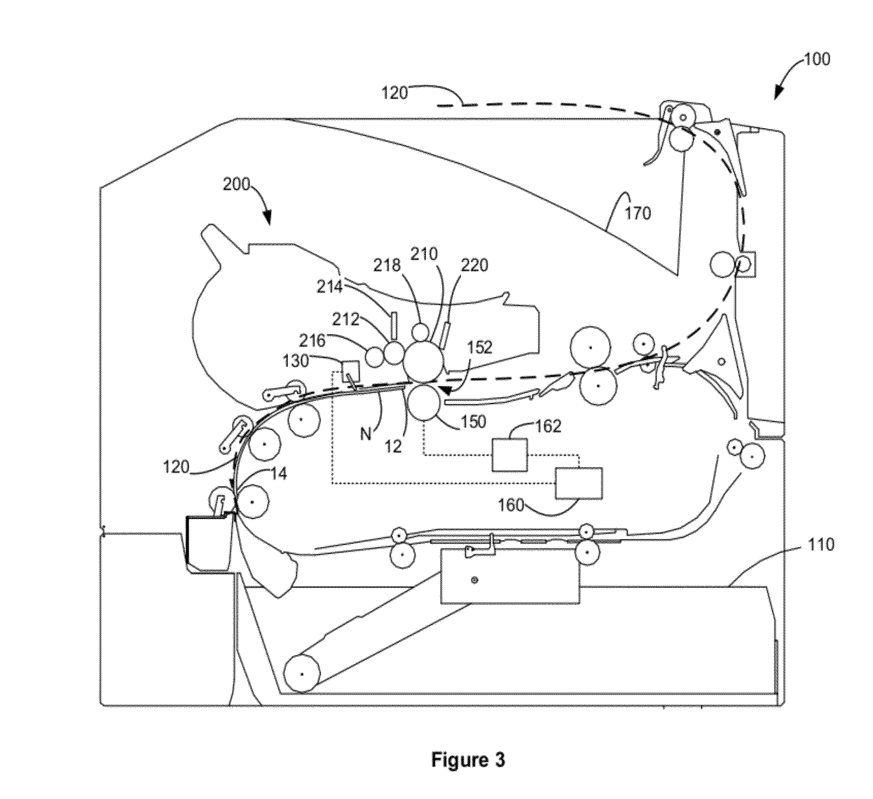

Disclosed is an electrophotographic imaging apparatus for imaging operations such as copying, printing, and the like that provides leading edge to trailing edge printing. The electrophotographic imaging apparatus provides high print quality throughout a media sheet, including up to its leading and trailing edges thereof. The disclosed electrophotographic imaging apparatus is explained in conjunction with FIG. 3.

FIG. 3 depicts an electrophotographic imaging apparatus 100 (hereinafter referred to as “apparatus 100”) that includes a media tray 110 to feed a media sheet N along a feed path 120 (dashed path) of the apparatus 100. Included in apparatus 100 is an imaging unit 200, such as a toner cartridge, including a photoconductive (PC) drum 210 on which is formed a latent and a toner image to be printed. Abutting the PC drum 210 is a developer roll 212 for supplying toner to the PC drum 210. A doctor blade 214, a form of a toner metering device, abuts the developer roll for ensuring an even layer of toner is on the surface of developer roll 212 prior to the toner being transferred to the PC drum 210. The developer roll 212 and the doctor blade 214 are electrically charged to charge the toner so that is it attached to the latent image on the PC drum to form the toner image. Also abutting the developer roll 212 is a toner adder roll 216 for creating a sump of toner between the toner adder roll 216 and the developer roll 212 for supplying toner to the developer roll 212 from a toner reservoir that may be housed within the imaging unit 200. A charge roll 218 abuts the PC drum 210 electrostatically charging it while an abutting cleaner blade 220 removes undeveloped toner particles from the surface of the imaging member 210 prior to charging by the charge roll 218.

The toner image corresponds to an original image that needs to be reproduced on the media sheet N into the image area 33. The term ‘reproduced’ and variables thereof as used herein above and below, relate to forming an image on the media sheet N by electrophotographic imaging techniques, such as copying, printing and the like.

The apparatus 100 further includes a media sensor 130 disposed on the feed path 120 in proximity to PC drum 210. The media sensor 130 changes state when a leading edge 22 of a media sheet N arrives at the media sensor 130 and when a trailing edge 24 of the media sheet N passes by the media sensor 130. A transfer roll 150 abuttingly couples with the PC drum 210 forming a transfer nip 152 through which media sheets pass to receive the toner image from PC drum 210. The transfer roll 150 which carries a transfer voltage that facilitates the transfer of the toner image from the PC drum 210 onto the surface of media sheet N when the media sheet N passes through the transfer nip 152. The charge supplied by the transfer roll 150 being at a thru-paper voltage or TPV to the media sheet N attracts the toner particles in toner image to the surface of the media sheet N and off of the PC drum 210. The TPV may be as high as 4000 volts and if the transfer voltage remained at the TPV value after the media sheet left the transfer nip 152 this high voltage would bias the PC drum so much that the charge roll 218 would not be able to properly condition the PC drum for imaging the next media sheet.

A controller 160 operatively coupled with the media sensor 130, and configured to determine and analyze dimensions of the original image, print area 31, image area 33, leading edge margin 21, trailing edge margin 23 and left and right margins 25, 27 of each media sheet as well as control other functions of the apparatus 100. The first portion of a media sheet N corresponds to a peripheral portion, and more specifically, a leading margin 21 of the media sheet N. The controller 160 is programmed to perform the below mentioned functions which control printing and operation of apparatus 100. Specifically, the controller 160 may receive signals (either by a wired connection or by a wireless connection) from the media sensor 130 once the media sensor 130 is triggered or changes state. One function of the controller 160 is to analyze a size of the original image (i.e., the overall area in which content of the image is present) to be reproduced as image area 33 on media sheet N, its placement within print area 31, a size of the border 29, and particularly, the leading margin 21 and trailing margin while executing a command (such as a “print page” command). The controller 160 controls electrophotographic operations, the functioning of the PC drum 210, the transfer roll 150, developer roll 212, toner adder roll 216, charge roll 218, media sheet N movement from being picked from media tray 110 along feed path 120 until the processed media is sent to an exit area 170, image data processing such as scaling and rasterizing, and the like.

Controller 160 sets the transfer roll 150 at a first transfer voltage, i.e., TPV (about 650-4000 v), when the toner image is to be transferred onto the media sheet 10. Specifically, the controller 160 sets the transfer roll 150 at the first transfer voltage when the toner image is to be transferred onto the media sheet N, based on the dimensions of the image area and the leading margin 21. More specifically, the controller 160 analyzes time required for the passage of the leading edge 22 of the media sheet N from the media sensor 130 to the transfer nip 152. Further, the controller 160 analyzes time required for the passage of the first portion (leading margin 21) of the media sheet N through the transfer nip 152. The controller 160 also analyzes the time required for the passage of a second portion, i.e. the image area 33 of the media sheet N through the transfer nip 152.

In addition, the controller 160 sets the transfer roll 150 at a second transfer voltage, i.e., interpage voltage or IPV (150 v), at a value less than the first transfer voltage when the controller 160 determines one of completion of the toner image transfer (i.e. the end of the image area 33) onto the media sheet N, arrival of the trailing margin 23, and arrival of the trailing edge 24 of the media sheet N at the transfer nip 152. Specifically, the controller 160 analyzes the time required for the passage of the trailing edge 24 of the media sheet N from the media sensor 130 to the transfer nip 152, the media sensor 130 changing state when the trailing edge 24 passes by it. For the purpose of this description, the second transfer voltage is shown to be lesser/smaller than the first transfer voltage. However, the apparatus 100 may be an electrophotographic imaging apparatus that requires a second transfer voltage to be higher/greater than the first transfer voltage. Accordingly and without departing from the scope of the present disclosure, the second transfer voltage may be a voltage that is higher/greater than the first transfer voltage.

The apparatus 100 may also include a variable power supply 162 electrically connected to the transfer roll 150 and operatively coupled with the controller 160 to provide the first transfer voltage TPV and the second transfer voltage IPV to the transfer roll 150 based on signals (either wired or wireless) received from the controller 160. Further, it will be evident that the apparatus 100 includes other components, such as driving rollers (not numbered) for driving the media sheet N along the feed path 120; a laser imaging system for discharging the PC drum 210 to create a latent image, and the like, as known in the art for the proper functioning of the apparatus 100.

For printing, a user may also set/define the border 29 by setting leading and trailing margins 21, 23, and left and right margins 25, 27 between which the image to be reproduced is printed. Specifically, the controller 160 process the image data to scale the image to fit within a user-defined border 29 and or the image area 33. Such a feature may provide an added level of reliability. For example, when the user selects an edge-to-edge mode of printing, the controller 160 may enforce a border of a default dimension (such as a 1 millimeter (mm)) around edges of the media sheet N. The enforced border may be adjustable from 0 mm (for true edge-to-edge printing) to 4 mm (default margins) of the media sheet N. In another implementation of the apparatus 100, both fixed timing and variable timing may be available for controlling the transfer voltage applied to transfer roll 150, with variable timing being enabled for edge-to-edge or leading edge to trailing edge modes of printing. Specifically, the timing of shift from the TPV to the IPV and vice-a-versa may be adjusted for the edges of the media sheet N when an edge-to-edge mode or leading edge to trailing edge mode is enabled for a particular job, thereby reducing the risk of print quality defects.

Based on the foregoing, the apparatus 100 provides sufficiently high edge-to-edge print quality while minimizing any fatigue on the PC drum 210 by adjusting transfer timings for transfer voltage of the transfer roll 150 based on size of the original/actual image content, the image area 33 (i.e., location of reproduced image on the media sheet 10) and its location within the print area 31 of the media sheet N. Accordingly, the apparatus 100 may dynamically adjust the transfer timings based on where the image area 33 begins and ends on the media sheet N, instead of having only fixed transfer timings that occur at predetermined distances from the leading and trailing edges 22, 24 of the media sheet N while constantly stressing the PC drum 210.

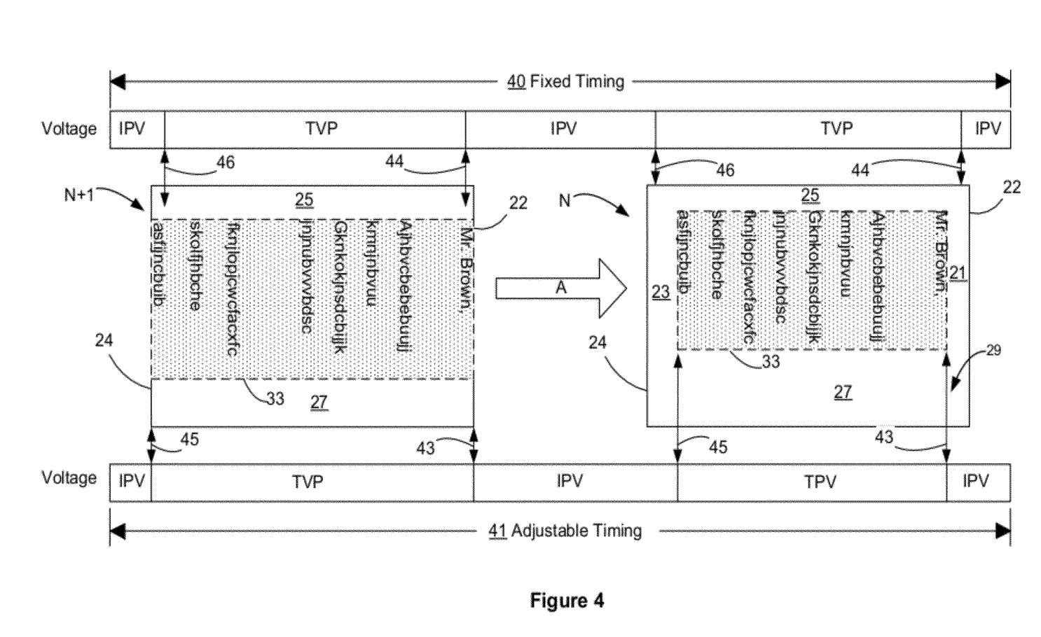

FIG. 4 illustrates a timing diagram depicting a fixed timing 40 and an adjustable timing 42 of the transfer roll 150 voltage of the apparatus 100. As depicted in FIG. 4, two different sample media sheets N, N+1 are shown along with two different sets of transfer timings, i.e., fixed timing 40 and adjustable timing 41 shown in relation to each of the two media sheets N, N+1. The process direction of printing is indicated by an arrow A. The media sheet N+1 is shown to have an image area 33 with content at or very close to a leading edge 22 and a trailing edge 24 of the media sheet N+1. The media sheet N is shown to have an image area 33 with content away from a leading edge 22 and a trailing edge 24 of the media sheet N. Both sheets are shown have left and right margins 25, 27 while media sheet N also has leading and trailing margins 21, 23. For the media sheet N+1, the fixed timing 40 indicates at 42 and 44 portions of the image area 33 on the leading and trailing edges 22, 24 of the media sheet N+1 may have poor transfer of toner onto the media sheet 20. The adjustable timing 41 indicates at 43, 45 that the transfer voltage may be shifted from the IPV to TPV and vice-a-versa for the entire media sheet N+1 based on the size of the image area 33 being printed resulting in sufficiently high print quality. For the media sheet N, which has a non-zero border 29 around image area 33 the fixed timing 40 indicates at 42 and 44 that IPV has transitioned to TPV prior to printing of image area 33 exposing the PC drum to this higher voltage than is actually needed for printing of image area 33. However for media sheet N, with adjustable timing 41 the transfer timings of TPV and IPV are adjusted at 43 and 45 to be at the portions of the media sheet N where the image area 33 is being printed not near the leading edge 22 and the trailing edge 44 reducing the time during which the PC drum sees the higher TPV. This also provides some energy savings in that with adjustable timing 41 the higher TPV is not applied to these type of media pages having leading and trailing margins 21, 23 as long as it is applied with the fixed timing 40.

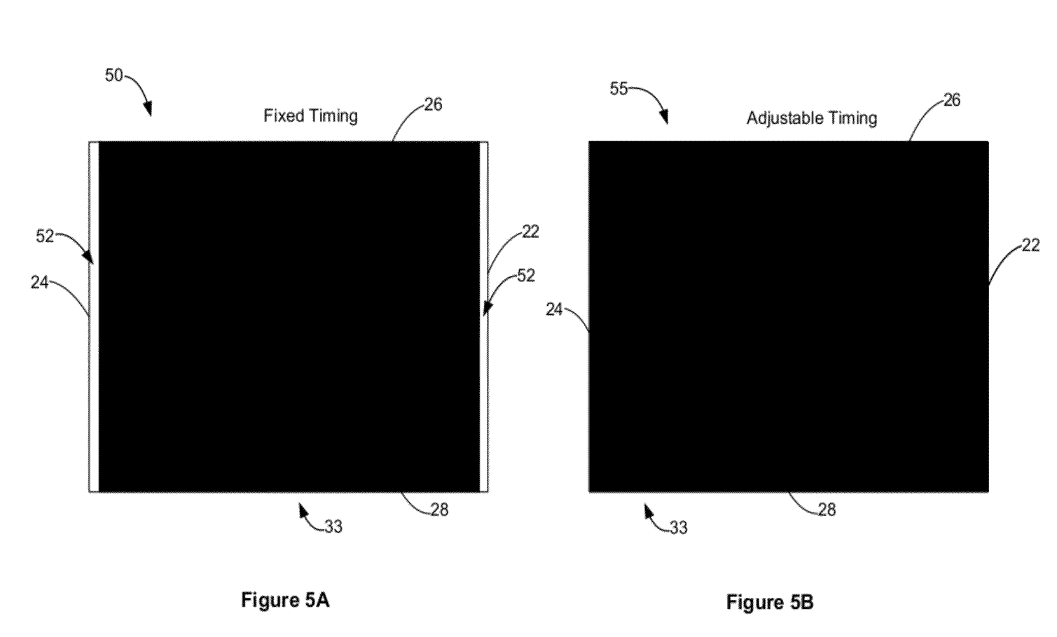

FIGS. 5A and 5B illustrate edge to edge printing examples using fixed timing 40 and variable timing 41 showing the image areas 33 on both media sheets printed as black blocks. FIG. 5A shows a media sheet 50 where because of use of fixed timing 40 printing near leading and trailing edges 22, 24 does not occur leaving the white bands 52. As shown printing to right and left edges 26 and 28 however can be achieved with fixed timing 40. FIG. 5B illustrates true edge to edge printing to all four edges 22, 24 26, 26 is available with variable timing 41

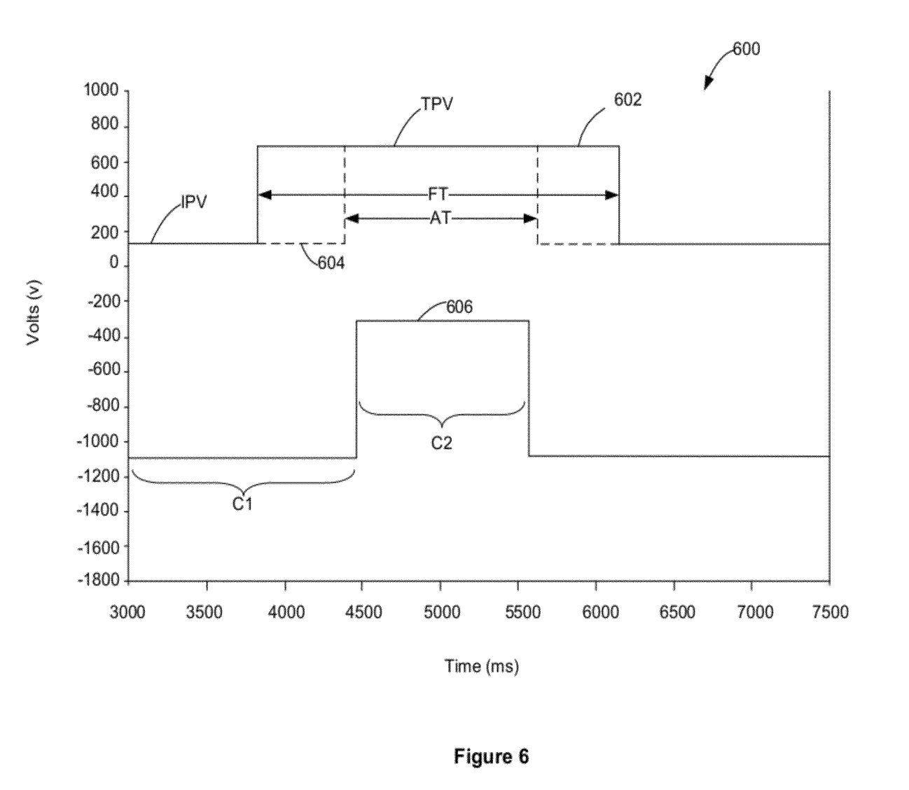

FIG. 6 illustrates a time versus voltage graph 600 for a prior art media sheet based fixed timing and the adjustable timing of the transfer roll 150 for the shift in the transfer voltage between the TPV and the IPV in related to the voltage appearing at the PC drum 210. As depicted, a voltage signal 602 for fixed timing indicates that the TPV is maintained as indicated by arrow FT based on the dimensions of a media sheet and extends beyond the image area to be printed on the media sheet. Alternatively and as depicted by voltage signal 604 shown in dashed line where it does not overlap voltage signal 602, the adjustable timing obtained using the apparatus 100 indicates that TPV value is maintained based on the dimensions of the image area 33 as indicated by arrow AT for a shorter duration of time. Further, the graph 600 depicts a voltage signal 606 for the voltage maintained at the PC drum 210. Specifically, the voltage signal 606 includes a portion C1 depicting the charged voltage of the PC drum 210 and a portion C2 depicting the discharged voltage of the PC drum 210 for image development/reproduction on a media sheet, such as the media sheet N. Accordingly, the adjustable timing of the transfer roll 150 of the apparatus 100 as illustrated by signal 604 facilitates in reducing the time of exposure of PC drum 210 to the higher TPV by the difference between arrows FT and VT.

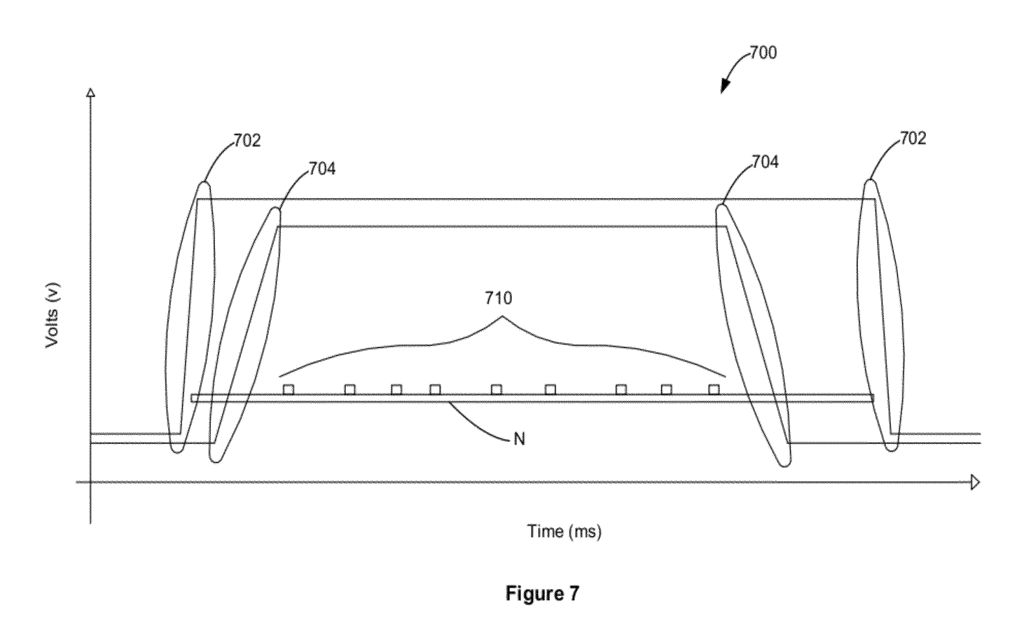

FIG. 7 illustrates a graph 700 depicting a comparison of transfer slew rates for conventional electrophotographic imaging apparatuses with transfer slew rates for the apparatus 100. As depicted by portions 702 in FIG. 7, faster transfer slew rates are required for the conventional electrophotographic imaging apparatuses in order to avoid exposure of bare photoconductor drums to high TPV (positive voltage) while attempting to transfer a toner image 710 on a media sheet N from a leading edge to a trailing edge thereof. Alternatively and as depicted by portions 704, transfer slew rates for the apparatus 100 are slower, thereby reducing any exposure of bare PC drum 210 to the high TPV (positive voltage) while attempting to transfer a toner image on the media sheet N from a leading edge to a trailing edge thereof.

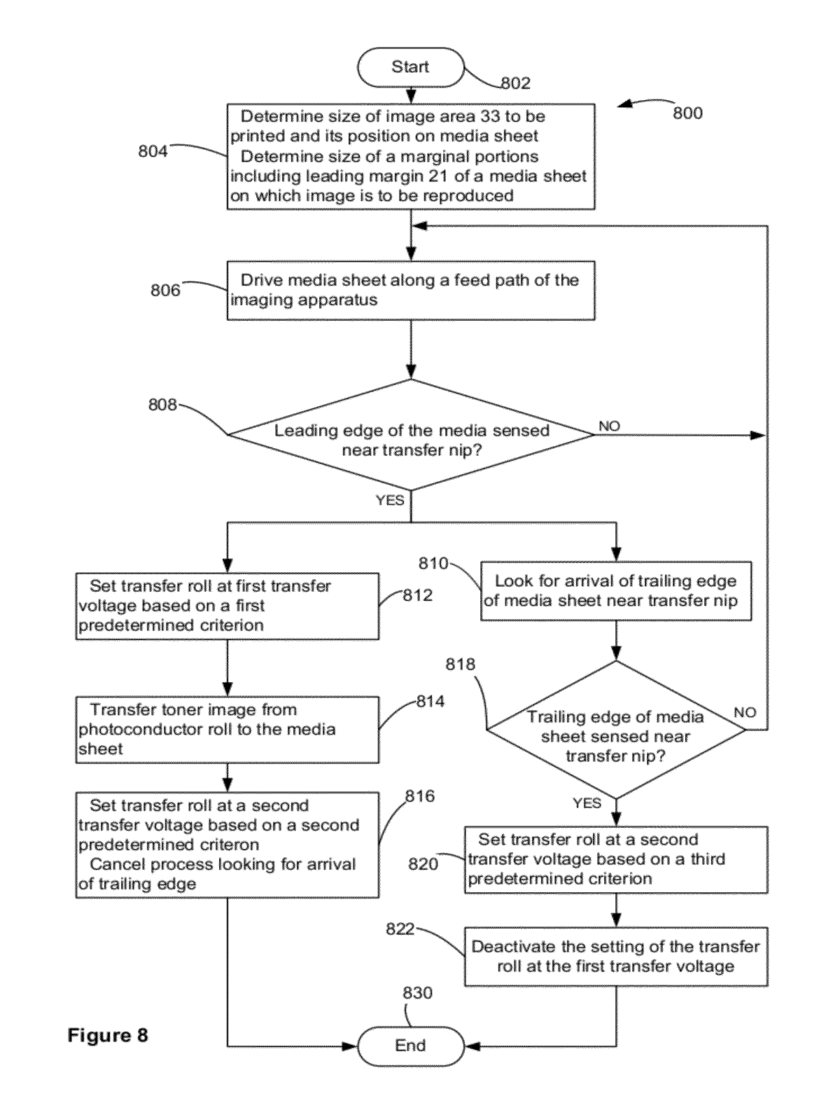

In another aspect, the present disclosure provides a method for reproducing (such as printing) an original image on a media sheet (such as the media sheet 10) by an electrophotographic imaging apparatus (such as the apparatus 100) of the present disclosure. The method of reproducing the original image on the media sheet N is explained in conjunction with FIG. 8. Further, the method has been explained while referring to the apparatus 100 and components thereof, as depicted in FIG. 3.

FIG. 8 illustrates a flow chart depicting a method 800 for reproducing an original image on the media sheet N by utilizing the apparatus 100 of FIG. 3. The method 800 begins at 802. At 804, dimensions of the image area 33 having the image to be reproduced and the position of the image area 33 on media sheet N are determined along with the size of a marginal portions such as leading margin 21 and the dimensions of media sheet N such as size of printable area 31 and border 29 determined by controller 160. At 806, the media sheet N is driven along the feed path 120 of the apparatus 100. At 808, the arrival of the leading edge 22 of the media sheet N at the media sensor 130 of the apparatus 100 is determined. If the leading edge 22 is not sensed, the media sheet continues to be driven along the feed path 120 at 806.

On determining that the leading edge 22 has arrived at the media sensor 130, the method 800 performs simultaneous processes. At 810 processor 160 continues to look for the arrival of the trailing edge 24 of the media sheet N at the media sensor 130. Simultaneously, the transfer roll 150 of the apparatus 100 is set at the first transfer voltage (TPV voltage) based on a first predetermined criterion, at 812. Specifically, the method 800 includes initiating a first timer, by the controller 160, on determining the arrival of the leading edge 22 at the media sensor 130. The first predetermined criterion refers to determining that a first count of the first timer exceeds a first time period. The first time period is determined by the controller 160, and is a time period required for the passage of the leading edge 22 of the media sheet N from the media sensor 130 to the transfer nip 152 and for the passage of the first portion following the leading edge 22 through the transfer nip 152. Further, the first count refers to the count of the first timer when the leading edge 22 of the media sheet N has passed from the media sensor 130 to the transfer nip 152 and the first portion has passed through the transfer nip 152. The controller 160 may operate the first timer and may also determine the first count.

At 814, the toner image from the PC drum 210 is transferred on the media sheet N. At 816, the transfer roll 150 is set at the second transfer voltage (IPV) based on a second predetermined criterion. As mentioned before and for the purpose of this description, the second transfer voltage may be smaller than the first transfer voltage. Alternatively, the second transfer voltage may be greater than the first transfer voltage.

The second predetermined criterion refers to determining that a second count of the first timer exceeds the summation of the first time period and a second time period. The second time period is determined by the controller 160, and is a time period required for the passage of a second portion (the image area 33) of the media sheet N through the transfer nip 152 while the toner image is being transferred to the media sheet N. Again for edge to edge printing the image area 33 would be coextensive with the media sheet N. For leading edge to trailing edge printing, the image area 33 would be coextensive with the length of the media sheet N in the process direction A or alternatively the height (in relation to the process direction A) of the leading margin 21 and trailing margin 23 would be zero. Further, the second portion receives the toner image that is to be reproduced on the media sheet 10. The second count may be determined by the controller 160, and may refer to the count of the first timer when the second portion of the media sheet N has reached the transfer nip 152 and has passed through the transfer nip 152.

Once the transfer roll 150 is set at the second transfer voltage, the process for determination of the arrival of the trailing edge 24 of the media sheet 10 at the media sensor 130 may be terminated for purposes of setting the transfer voltage. In other words, the process set forth at 818, 820, and 822 would not be performed. The method 800 then ends at 830.

At 818, the arrival of the trailing edge 24 of the media sheet N is determined. If the trailing edge 24 has not arrived the media sheet N continues to be driven at 806 along the feed path 120. Alternatively, the method 800 also includes initiating a second timer, by the controller 160, at 818 on determining the arrival of the trailing edge 24 at the media sensor 130 and on determining that the second count of the first timer is less than the summation of the first time period and the second time period. Subsequently, the transfer roll 150 is set at the second transfer voltage after the arrival of the trailing edge 24 at the transfer nip 152 based on a third predetermined criterion, at 820. The third predetermined criterion refers to determining that a count of the second timer exceeds a third time period. The third time period is determined by the controller 160, and is a time period required for the passage of the trailing edge 24 of the media sheet N from the media sensor 130 to the transfer nip 152. The count of the second timer refers to the count when the trailing edge 24 of the media sheet N has passed from the media sensor 130 to the transfer nip 152. The controller 160 may determine the count of the second timer. At 822, the setting of the transfer roll 150 at the first transfer voltage is deactivated. The method ends at 830.

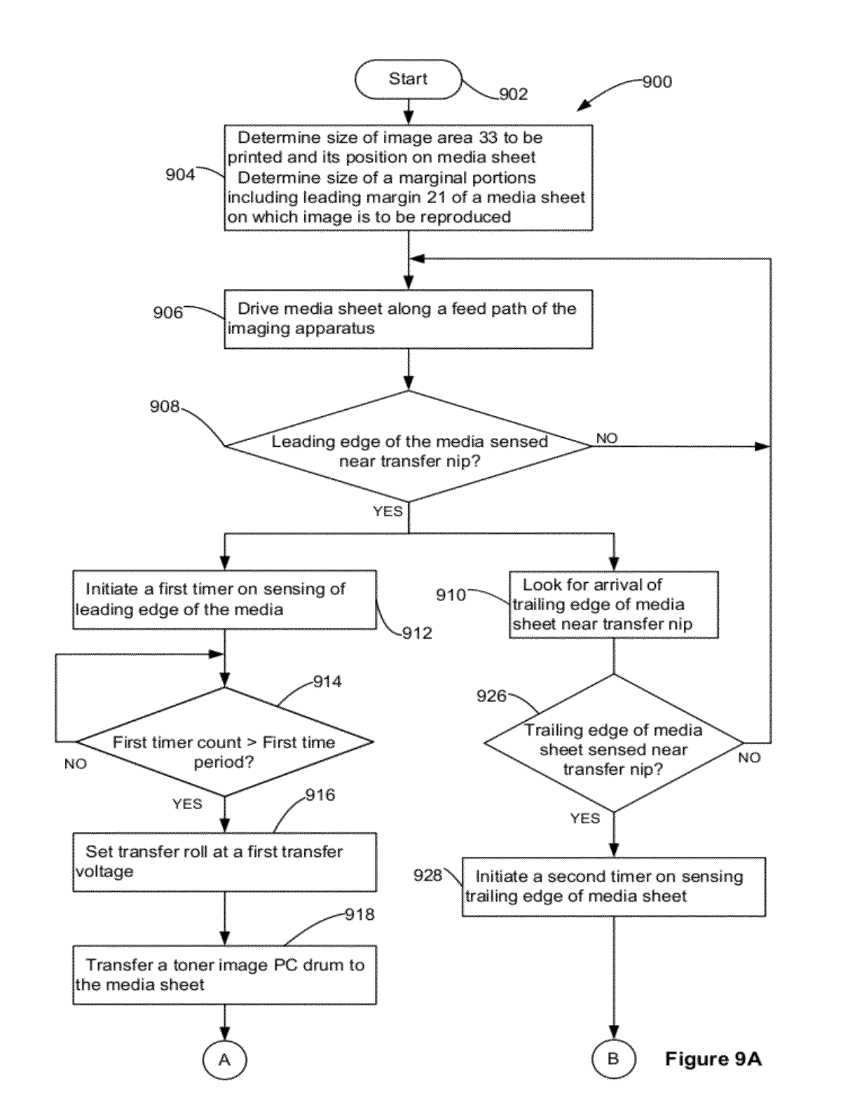

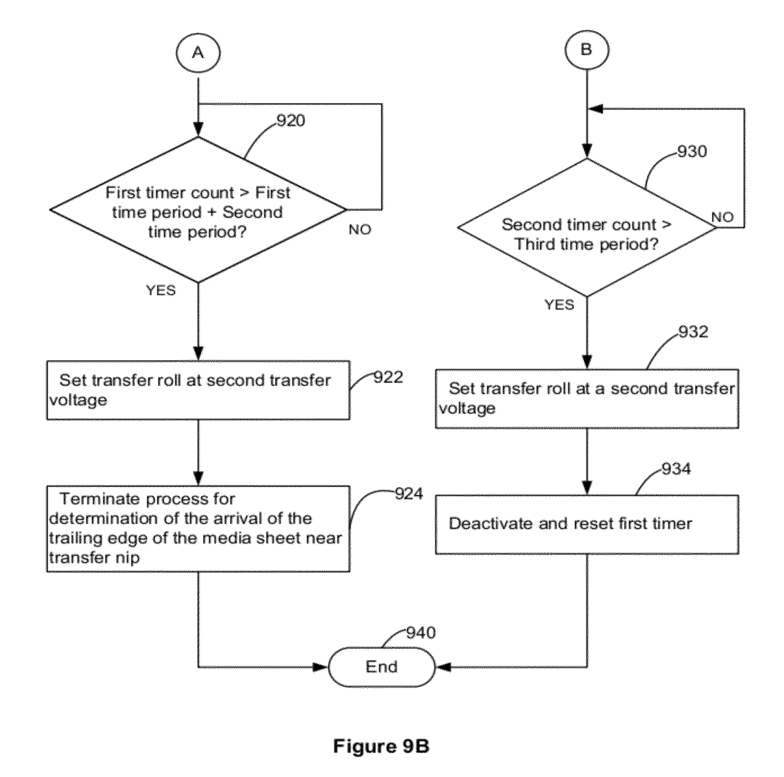

In yet another aspect, the present disclosure provides a method for reproducing (such as printing) an original image on a media sheet (such as the media sheet N) by an electrophotographic imaging apparatus (such as the apparatus 100) of the present disclosure. The method of reproducing the original image on the media sheet N is explained in conjunction with FIGS. 9A and 9B. Further, the method has been explained while referring to the apparatus 100 and components thereof, as depicted in FIG. 3. Without departing from the scope of the present disclosure, the method as explained below is represented for a detailed explanation of the method 900.

FIGS. 9A and 9B illustrate a flow chart depicting a method 900 of reproducing an original image on the media sheet N by utilizing the apparatus 100. The method 900 begins at 902. At 904, dimensions of the image area 33 and the marginal portions 21, 23, 25, 27 in a first portion (leading margin 21) of the media sheet N are determined and analyzed by the controller 160. At 906, the media sheet N is driven along the feed path 120 of the apparatus 100. At 908, the arrival of the leading edge 22 of the media sheet N at the media sensor 130 is determined. If the leading edge 22 the media sheet continues to be driven along feed path 120 at 906.

On determining that the leading edge 22 has arrived at the media sensor 130, the method 900 performs simultaneous processes. In one process starting at 912, a first timer is initiated by the controller 160 on determining the arrival of the leading edge 22 at the media sensor 130. The method 900 includes determining whether a first count of the first timer exceeds a first time period, at 914. The first time period is determined by the controller 160, and is a time period required for the passage of the leading edge 22 of the media sheet N from the media sensor 130 to the transfer nip 152 and for the passage of the first portion (e.g. leading margin 21) following the leading edge 22 of the media sheet N through the transfer nip 152. At 916, the transfer roll 150 is set at the first transfer voltage when the first count exceeds the first time period. At 918, the toner image is transferred from the PC drum 210 to the second portion (e.g. the image area 33) of the media sheet N reproducing the original image on the media sheet N.

At 920, the method 900 includes determining whether a second count of the first timer exceeds the summation of the first time period and a second time period. The second time period is determined by the controller 160, and is a time period required for the passage of the second portion (e.g. image area 33) through the transfer nip 152 while the toner image is being transferred to the media sheet N.

At 922, the transfer roll 150 is set at the second transfer voltage when the second count exceeds the summation of the first time period and the second time period. Specifically, the second count may exceed the summation of the first time period and the second time period when a length of the media sheet N is greater than the dimensions of the image area and the first portion of the media sheet N. Once the transfer roll 150 is set at the second transfer voltage (e.g. IPV), at 924 the determination of the arrival of the trailing edge 14 of the media sheet 10 at the media sensor 130 may be terminated. The method 900 then ends at 940.

Alternatively, at 926, the arrival of the trailing edge 24 of the media sheet N is determined. If the trailing edge 24 has not arrived the media sheet N continues to be driven at 906 along the feed path 120. At 928, a second timer is initiated on determining the arrival of the trailing edge 24 at the media sensor 130. At 930, the method 900 includes determining whether a count of the second timer exceeds a third time period. The third time period is determined by the controller 160, and is a time period required for the passage of the trailing edge 24 of the media sheet N from the media sensor 130 to the transfer nip 152. At 932, the transfer roll 150 is set at the second transfer voltage (IPV) when the count exceeds the third time period. The count may exceed the third time period when the length of the media sheet N is smaller than the dimensions of the image area 33 and the first portion (leading margin 21) of the media sheet N. At 934, the first timer is reset and deactivated. Subsequently, the method ends at 940.

Because of scaling, the toner image may be smaller or larger than the original image accordingly the size of the image area 33 needs to be determined in relation to the leading margin and the trailing margin. The leading edge 33L of the image area 33 may abut the end of leading margin 21 or abut leading edge 31L of the printable area 31 or may be spaced downstream thereof. In the former, setting the first transfer voltage may occur when either the location of the bottom of the leading margin 21 or the location of leading edge 33L of the image area within printable area 31 is determined to be at the transfer nip 152. In the latter, setting of the first transfer voltage occurs when the location of the leading edge 33L is determined to be at the transfer nip 152. The trailing edge 33T the image area 33 may abut the trailing margin 23 or trailing edge 31T of the printable area 31 or be spaced upstream thereof. The second predetermined condition for setting the transfer voltage at second level may occur when the position of the trailing edge 31T of the image area 33 is determined to be less than the top of the trailing margin 23 or the trailing edge 31T of the printable area 31. When the leading edge 33L of image area 33 is coincident with leading edge 22 the setting of the first transfer voltage would occur when the leading edge 22 of media sheet N was determined to be in the transfer nip 152. Similarly when the trailing edge 33T of media area 33 is coincident with trailing edge 24 of media sheet N, the setting of the second transfer voltage would occur when the trailing edge 24 of the media sheet is determined to be at the transfer nip. Because the speed at which media sheet N is being driven along feed path 120 is known to the controller 160, the use of the timer being triggered by the change of state of the media sensor 130 allows the positions of the various leading and trailing edges of the different regions of the media sheet to be determined.

The present disclosure provides an electrophotographic imaging apparatus (such as the apparatus 100) and a method (such as the methods 800 and 900) for reproducing an original image on a media sheet that serve an effective and efficient tool for edge-to-edge printing (i.e., by offering better print accuracy along all edges of the media sheet) while minimizing overall reliability to the electrophotographic imaging apparatus and meeting customer needs. Further, the electrophotographic imaging apparatus and the method of the present disclosure may be utilized for everyday copy and print applications; applications that require full page addressability, such as All-in-One (AIO) applications; and applications that have tight registration requirements where the electrophotographic imaging apparatus needs to adjust to the application type. Furthermore, the electrophotographic imaging apparatus and the method of the present disclosure provide more robust edge to edge printing support and leading edge to trailing edge printing, and relaxes slew time requirements of High Voltage Power Supply (HVPS) while serving as a lower cost design as opposed to the prior art designs.

The foregoing description of several embodiments of the present disclosure has been presented for purposes of illustration. It is not intended to be exhaustive or to limit the disclosure to the precise forms disclosed, and obviously many modifications and variations are possible in light of the above teaching. It is intended that the scope of the disclosure be defined by the following claims.

What is claimed is:

1. An electrophotographic imaging apparatus comprising:
a feeding tray adapted to feed a media sheet along a feed path of the electrophotographic imaging apparatus;
a media sensor disposed on the feed path, the media sensor changing state when a leading edge of the media sheet arrives at the media sensor and changing state when a trailing edge of the media sheet arrives at the media sensor;
an image carrying member proximate to and downstream of the media sensor for carrying a toner image thereon, wherein the toner image is to be transferred to the media sheet;
a transfer roll abuttingly coupled with the image carrying member to form a transfer nip therebetween, the transfer roll transferring of the toner image from the image carrying member onto the media sheet when the media sheet passes through the transfer nip; and
a controller operatively coupled with the media sensor and transfer roll, the controller determining the dimensions of an image area containing the toner image to be reproduced on the media sheet and a first portion of the media sheet, the controller adjusting a transfer roll voltage between a first transfer voltage and a second transfer voltage based on a location of a leading edge and a location of a trailing edge of the image area on the media sheet, the controller setting the transfer roll at a first transfer voltage when the leading edge of the image area arrives at the transfer nip, the controller further setting the transfer roll at a second transfer voltage when the controller determines one of the arrival of the trailing edge of the image area onto the media sheet and arrival of a trailing edge of the media sheet at the transfer nip.

2. The electrophotographic imaging apparatus of claim 1, wherein the controller determines the time required for the passage of the leading edge of the media sheet from the media sensor to the transfer nip.

3. The electrophotographic imaging apparatus of claim 2, wherein the controller is further determines a time required for the passage of the first portion of the media sheet through the transfer nip.

4. The electrophotographic imaging apparatus of claim 3, wherein the first portion is a leading margin of the media sheet.

5. The electrophotographic imaging apparatus of claim 4, wherein the leading margin of the media sheet has a zero height.

6. The electrophotographic imaging apparatus of claim 3, wherein the controller determines a time required for the passage of the image area of the media sheet following the first portion of the media sheet through the transfer nip.

7. The electrophotographic imaging apparatus of claim 6, wherein a trailing edge of the image area coincides with the trailing edge of the media sheet receiving the toner image.

8. The electrophotographic imaging apparatus of claim 1, wherein the controller further determines the time required for the passage of the trailing edge of the media sheet from the media sensor to the transfer nip.

9. A method for reproducing an image on a media sheet corresponding to an original image by an electrophotographic imaging apparatus, the method comprising:
determining the dimensions of an image area containing the image to reproduced and a leading margin and trailing margin of the media sheet;
driving the media sheet along a feed path of the electrophotographic imaging apparatus;
determining an arrival of a leading edge of the media sheet at a media sensor of the electrophotographic imaging apparatus;
determining an arrival of a trailing edge of the media sheet at the media sensor;
setting an transfer roll of the electrophotographic imaging apparatus at a first transfer voltage based on a first predetermined criterion;
transferring a toner image from photoconductive drum of the electrophotographic imaging apparatus to the media sheet at a transfer nip formed between the photoconductive drum and the transfer roll; and
setting the transfer roll at a second transfer voltage based on a second predetermined criterion.

10. The method of claim 9 further comprising initiating a first timer on the arrival of the leading edge of the media sheet at the media sensor.

11. The method of claim 10, wherein the first predetermined criterion comprises determining a first count of the first timer being exceeding a first time period, the first time period being a time period required for the passage of the leading edge of the media sheet from the media sensor to the transfer nip and for the passage of the leading margin following the leading edge of the media sheet through the transfer nip.

12. The method of claim 11, wherein the second predetermined criterion comprises determining a second count of the first timer exceeding the summation of the first time period and a second time period, the second time period being a time period required for the passage of the image area following the leading margin through the transfer nip while the toner image is being transferred to the media sheet.

13. The method of claim 12, further comprising initiating a second timer on determining the arrival of the trailing edge of the media sheet at the media sensor, when the second count of the first timer is less than the summation of the first time period and the second time period.

14. The method of claim 13, further comprising:
setting the transfer roll at the second transfer voltage after the arrival of the trailing edge at the transfer nip based on a third predetermined criterion, the third predetermined criterion comprising determining a count of the second timer exceeding a third time period, the third time period being a time period required for the passage of the trailing edge of the media sheet from the media sensor to the transfer nip; and
deactivating the first timer.

15. The method of claim 9 wherein the second predetermined condition occurs when the trailing edge of the image area is determined to be less than a leading edge of the trailing margin.

16. A method for reproducing an original image on a media sheet by an electrophotographic imaging apparatus, the method comprising:
determining and analyzing dimensions of the original image, an image area containing an image to be reproduced and a border of the media sheet, the border having a leading margin, a trailing margin, a left margin and a right margin in relation to a process direction;
driving the media sheet along a feed path in the process direction;
determining an arrival of a leading edge of the media sheet at a media sensor of the electrophotographic imaging apparatus;
simultaneously beginning a process to determine the arrival of a trailing edge of the media sheet at the media sensor and initiating a first timer on the arrival of the leading edge at the media sensor;
determining whether a first count of the first timer exceeds a first time period, the first time period being a time period required for the passage of the leading edge of the media sheet from the media sensor to a transfer nip and for the passage of the leading margin following the leading edge of the media sheet through the transfer nip, the transfer nip being formed between an photoconductive drum and an transfer roll of the electrophotographic imaging apparatus;
setting the transfer roll at a first transfer voltage when the first count exceeds the first time period;
transferring at the transfer nip the toner image from the photoconductive drum to the image area of media sheet in order to reproduce the original image on the media sheet;
determining whether a second count of the first timer exceeds the sum of the first time period and a second time period, the second time period being a time period required for the passage of the image area through the transfer nip while the toner image is being transferred to the media sheet; and
setting the transfer roll at a second transfer voltage when the second count exceeds the summation of the first time period and the second time period.

17. The method of claim 16, wherein the second count exceeds the summation of the first time period and the second time period when length of the media sheet is greater than a height of the image area and the leading margin of the media sheet.

18. The method of claim 16, further comprising:
initiating a second timer on determining the arrival of the trailing edge at the media sensor;
when the second count of the first timer is less than the sum of the first time period and the second time period, determining whether a count of the second timer exceeds a third time period, the third time period being a time period required for the passage of the trailing edge of the media sheet from the media sensor to the transfer nip;
setting the transfer roll at the second transfer voltage when the count of the second timer exceeds the third time period; and
deactivating the first timer.

19. The method of claim 18, wherein the count of the second timer exceeds the third time period when length of the media sheet is less than a height of the image area and the leading margin.

20. The method of claim 18, wherein a height of the leading and trailing margins is zero.

21. The method of claim 19, wherein a width of the right and left margins is zero.
